(19) United States
(12) Patent Application Publication
(10) Pub. No.: US 2009/0036093 A1
(43) Pub. Date: Feb. 5, 2009

(54) PHONE CALL ACTIVATION AND BILLING SYSTEM

(76) Inventors: R. William Graham, Dayton, OH (US); Chad Kouse, Kettering, OH (US)

Correspondence Address: R. William Graham, 22 S. St. Clair St., Dayton, OH, 45402, US

(21) Appl. No.: 11/845,460

(22) Filed: Aug. 27, 2007

Related U.S. Application Data
(60) Provisional application No. 60/953,702, filed on Aug. 3, 2007.

(51) Int. Cl. H04M 11/00; H04Q 7/20

(52) U.S. Cl. 455/406; 455/422.1

(57) ABSTRACT

A phone call activation and billing system using the Internet, which includes a user's phone, a first CPU operably associated with said user's phone, the first CPU having operating hardware and software and web browser software operably connected to the Internet to permit communicating with search engine software to generate a listed telephone number at a search engine page and software for activating a call between a second phone associated with the listed telephone number and said user's phone associated with a user's number. Software is provided for billing time associated with the call.

### BACKGROUND OF THE INVENTION

1. Field of the Invention

The present invention relates to phone call activation and billing system. More particularly, this invention relates to phone call activation over the Internet and a billing system which enables recovery of billable phone time through web enabled applications.

2. Related Art

There exists a number of software billing systems in the art. These commonly include a manual entry of time and enable in-house creation of a bill for time spent on a phone with a client. Other systems have attempted to automate the process by automatically tracking phone time when a client calls a service provider, but these systems fail to adequately address the problems associated with billing phone time in today's Internet crazed environment.

For example, some of these systems require that the service provider input time and then create a bill and take additional time to process or collect for their time rendered. However, the trend of professionals is to become more self-sufficient in their jobs and often requires the professional, accountant or lawyer for example, to become more computer-interactive and produce much of the work product. In addition, competition has led to various forms of advertising and most notably the Internet.

In the context of sponsored and non-sponsored search engines, someone looking to discuss a particular matter with a professional, such as an attorney, generates a query and typically is generated a list of potential professionals, e.g., attorneys, from which to choose. In the case of clicking on sponsored links to the professional, this typically costs the professional a designated fee which is agreed upon by the web search engine provider and the professional advertising through such engine. Additionally, the person search will likely call the professional and this can generate significant lost revenue to the professional in the way of free phone time.

Accounting for phone time remains troublesome. This is due to the fact that many of the calls which are made or received on behalf of a client may only account for a couple of minutes time to the professional and becomes either a nuisance to the professional to administratively log, bill and follow up weighed against the actual amount of time billed. Additionally, when the professional currently logs phone call time, it is commonly done in a preset increment of an hour, such as a sixth (10 minutes) of an hour, to account not only for the phone time, but also for the administrative time for billing and accounting. This can result in the client being over charged for the actual professional time spent.

Accordingly, there remains a need for improved access between parties using the Internet and an improved billing system using the Internet. The present invention overcomes these problems.

### BRIEF SUMMARY OF THE INVENTION

It is an object to improve communication using the Internet.

It is another object to improve phone call activation using the Internet.

It is another object to improve search engines over the Internet.

It is an object of the present invention to improve billing systems.

It is another object to improve the equipment used in a billing system.

Accordingly, one embodiment of the invention is directed to a phone call activation system using the Internet. The system includes a first CPU the having conventional operating hardware and software and web browser software operably connected to the Internet to permit communicating with search engine software to generate a listed telephone number at a search engine page and means for activating a call between the listed telephone number and another telephone number which can be predetermined or entered at the search engine page. The activating means can include a pop-up window at the search engine page which enables inputting a telephone number to be connected with the listed telephone number.

Another aspect to the present invention is directed to a billing system for enabling a user to call a service provider and service provider to bill the user for the call. The billing system includes a telephone and a first CPU, wherein the telephone may include the first CPU. The first CPU includes conventional operating hardware and software and web browser software communicating with search engine software to generate a listed service provider on a search engine page and associated telephone number.

Software is provided which upon a user selecting (such as by clicking) on a telephone number generated from the search engine software, a calling charge can be accrued and billed to the user with payment to the chosen service provider. This can be performed in several ways as discussed hereinafter. Additionally, a signal is generated to initiate the telephone to call the service provider. This can be done through the first CPU, or a blue tooth connection software, or other suitable connection. Once the call is placed and completed, the user is charged for the call and the service provider is paid. Additionally, the invention contemplates paying third party fees, such as search engine fees as a means for transacting such business. An alternative embodiment envisions the service provider paying the user for initiating the call through the search engine.

Other objects and advantages will be readily apparent to those skilled in the art upon viewing the drawings and reading the detailed description hereafter.

### BRIEF DESCRIPTION OF THE DRAWINGS

FIG. 1 depicts a current search engine page.

FIG. 2 depicts another current search engine page and query result.

FIG. 3 depicts a search engine page as modified with the present invention.

FIG. 4 depicts another search engine page as modified with the present invention.

FIG. 5 depicts still another search engine page as modified with the present invention.

FIG. 6 depicts yet another search engine page as modified with the present invention.

FIG. 7 is a schematic of the invention.

### DETAILED DESCRIPTION OF THE INVENTION

Referring now to the drawings, the phone call activation and billing system of the present invention is generally referred to by the numeral 10. The phone call activation and billing system 10 includes a CPU 11 and a telephone device 12, which can be a cell phone with suitable communication software thereon including blue tooth™ technology, for example, a conventional phone communicably linked to the CPU 11 or integrally connected as part of CPU 11.

It is contemplated that other voice communication means may be employed, for example, voice activation and communication through the CPU 11, and that these devices are contemplated within the invention. It is understood that CPU 11 has operably associated memory and operating system, clock, monitor, mouse, keyboard, operating hardware, etc., operating software and browser software, such as Internet Explorer, Netscape, etc.

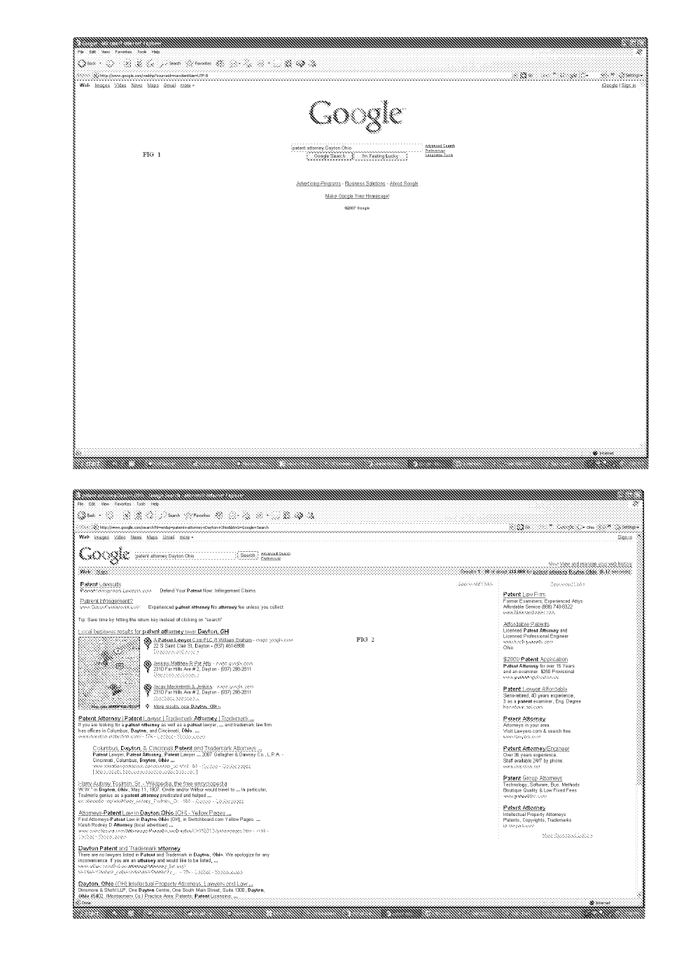

The invention contemplates the use of the browser software to permit searching over the Internet and particularly searching using a search engine such as Google. As seen in FIG. 1, a user can generate a query for a service provider, such as “patent attorney Dayton Ohio” at a search engine page.

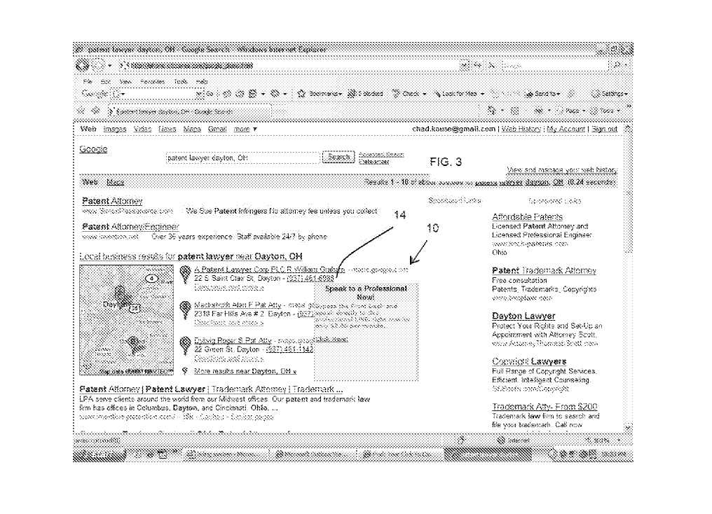

By initiating the search engine software, a list of service providers and associated telephone numbers is generated on another search engine page. This is represented in FIG. 2. Currently without the aid of the instant invention, the user is then left to select and call the service provider using conventional means, specifically by placing a call on one's phone. The service provider is faced with answering a potentially unidentified or unknown caller without being paid for the call time. These results in the problems discussed above.

With the aid of the instant invention, backbone structure now exists which enables phone activation of a call between the listed phone number and a desired phone of the user. In this way, the service provider can recoup on their phone time. Optionally, the service provider can compensate for the call generated as a result of it being placed through the search engine web page.

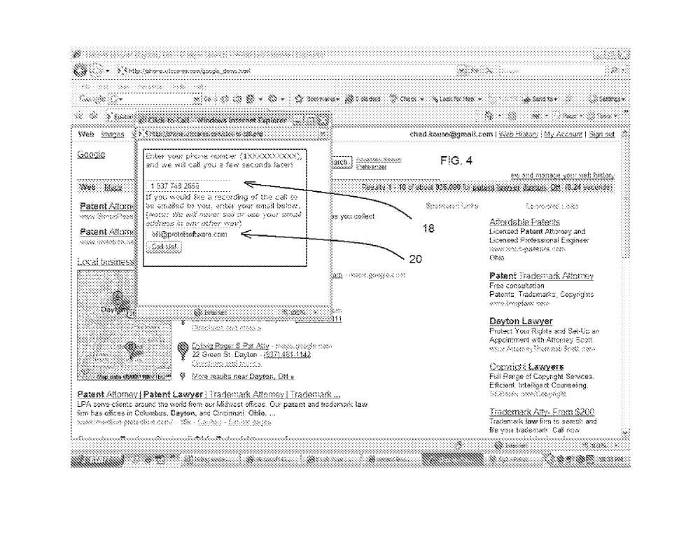

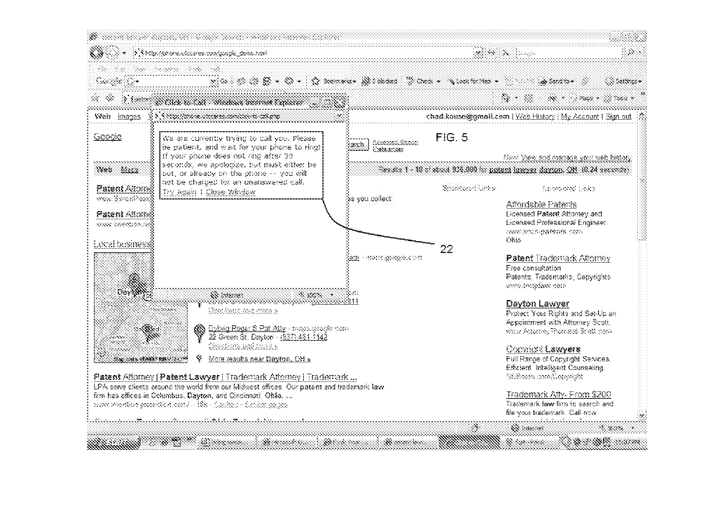

Accordingly, FIG. 3 represents a step performed by phone activation and billing software 15 of the instant invention whereupon a user clicking on a telephone number 14 generated from the search engine software on the search engine page, whether a sponsored list or not, a call can be initiated between the user's phone 12 and a service provider's phone 16. It should be understood herein that the term “phone activation and billing software 15” is contemplated to include one or more features of the described invention, including phone activation, phone call billing, call recording and/or e-mailing functions described herein. As seen in FIG. 4, a phone number window 18 is provided wherein the user can enter his/her phone number to be called, for example, “937-454-1888”. Additionally, an e-mail window 20 is provided wherein the user can enter his/her e-mail address bill@protelsoftware.com to be sent a an email wherein the present software provides voice recorded data of the initiated phone call, for example, for billing verification.

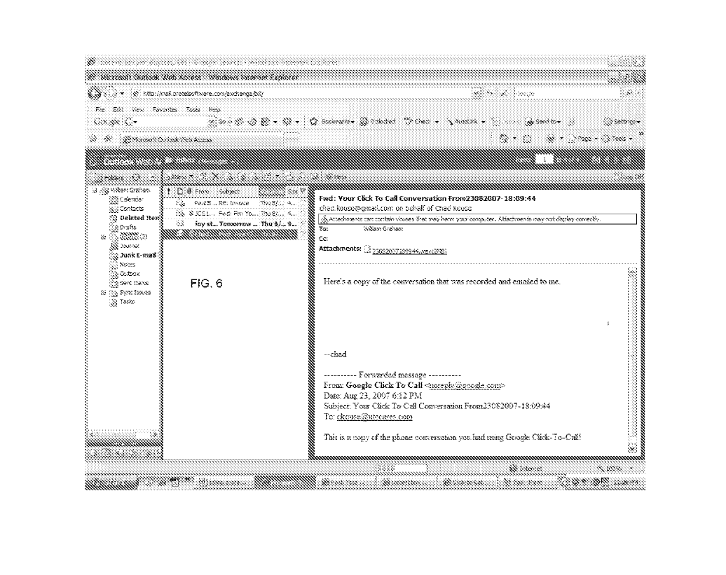

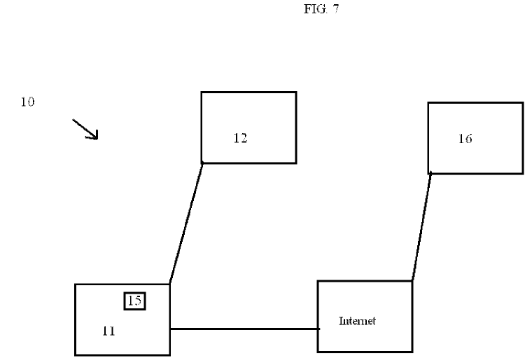

As seen in FIG. 5, once the user has entered a phone number and clicked the call button, “call us”, the phone activation and billing software 15 provides a window alerting the user that a call is being attempted. Here, the phone activation and billing software 15 provides for placing a call to the service provider and includes means for verifying that a live person is taking a call, such as prompting a service provide to enter a predetermined key on the phone. This process can preferably be performed by an automated attendant in the software of the invention. Additionally, the phone activation and billing software 15 of the invention can provide for the service provider to input a key code to start the billing of the call. This key code can also preferably initiate a phone call recording for purposes of billing verification wherein the software can store the recording for retrieval. The phone activation and billing software 15 is also equipped to automatically e-mail the voice data as seen in FIG. 6. The phone activation and billing software 15 is equipped to provide a call charge to be accrued at a predetermined amount or rate. For example, the call can be billed to the user with payment going to the chosen service provider (or the service provider can pay for the call in the case of paying for leads to the search engine). Here, the parties are informed that they can speak directly with the each other at an agreed upon rate. The phone activation and billing software 15 is equipped to permit a service provider (or the listed number) to be activated/deactivated at predetermined times, such as on during certain times of the day and off at night for example.

By clicking on the “call us” button displayed, the phone activation and billing software 15 of the invention initiates a signal to commence the phone call through the telephone device 12 described above. The invention contemplates that the phone activation and billing software 15 of the instant invention can reside on a cell phone in which the user is employing browser software thereon, in which case the resident phone activation and billing software 15 initiates the call to the service provider and tracks the call time and such information can be transmitted and stored using a remote server. In another instance, it is contemplated that the user is employing the browser software on a laptop or desktop CPU in which case, a signal can be transmitted via blue tooth, for example, to initiate the call as well as permit tracking call time and billing thereof. Optionally, the phone activation and billing software 15 can reside remotely and use web based applications to perform initiation and tracking of call time through computers over the networks. In such case, a signal can be sent to the phone to accept charges for the call. It is understood that other modifications, derivations and improvements of performing this aspect of the invention will be readily apparent to persons skilled in the art.

The backbone structure for the instant invention provides phone activation and billing software 15 which can be remotely located on a server CPU, for example. The phone activation and billing software can be preloaded at the time of phone set up through a phone service provider or use web based applications, for example. Real time or prior acquired billing information data from the user, such as through a credit card system, can be obtained. Additionally, the phone activation and billing software 15 serves as a conduit through which the search engine provider, user and service providers provide necessary account information data in order to receive payment from the prospective user. It is also contemplated that service provider can be a user and provide billing information data. It is contemplated that the user telephone number can be on an established account with a telephone service provider, and the phone activation and billing software 15 is equipped to bill the predetermined charges through such established account. It is further contemplated that the phone activation and billing software 15 can be operatively residing on local CPU or remote CPU and can be web-based such that browser technology can be employed to use of the software.

Billing information data acquired by the phone activation and billing software 15 can include client name, contact name, street address, city address, state zip code, country, work, fax and home telephone, credit card information and a unique identification, etc. for each party. Likewise, the phone activation and billing software provides for acquiring service provider data, such as service provider name, service provider name, street address, city address, state zip code, country, work, fax and home telephone, predetermined types of charge date, deposit account information and unique identification for the service provider. Further, the phone activation and billing software 15 provides for associating and accruing charges of predetermined types of services obtained or used by a particular user and writing and storing all accrued charges into a billing data file.

The phone activation and billing software 15 can be operably connected with means for generating an invoice (by way of any suitable printing or electronic means) to the user on behalf of the service provider or search engine provider, for example. Herein, the invoice generated would include listing the user data and service provider data with itemized call time data (i.e., services provided).

The above described embodiments are set forth by way of example and are not for the purpose of limiting the present invention. To name a few, the invention can have application for attorneys, accountants, programmers, celebrities, physicians, engineers, as well as numerous other service providers. A search page as discussed herein is intended to include an active web page wherein a query can be performed at such page to generate a results listing in response to the queried data. It will be readily apparent to those skilled in the art that obvious modifications, derivations and variations can be made to the embodiment without departing from the scope of the invention. Accordingly, the claims appended hereto should be read in their full scope including any such modifications, derivations and variations.

What is claimed is:

1. A phone call activation system using the internet, which comprises:
a user's phone having an associated telephone number;
a first CPU operably associated with said user's phone, said first CPU having operating hardware and software and web browser software operably connected to the Internet to permit communicating with search engine software to generate a listed telephone number at a search engine page; and
means for activating a call between a second phone associated with said listed telephone number and said user's phone associated with said user's telephone number.

2. The phone call activation system using the Internet of claim 1, wherein said activating means is equipped to permit entry of a phone number associated with said user's phone.

3. The phone call activation system using the Internet of claim 1, wherein said user's phone is called using wireless electronics.

4. The phone call activation system using the Internet of claim 1, wherein said activating means is equipped to permit entry of an email address.

5. The phone call activation system using the Internet of claim 1, wherein said activating means is equipped for recording said call between said phones to produce recorded call data.

6. The phone call activation system using the Internet of claim 5, wherein said activating means is equipped for automatically transmitting said recorded call data to one of said user and said service provider.

7. The phone call activation system using the Internet of claim 1, wherein said activating means is equipped to send a prompt signal to said second phone to initiate said recording.

8. The phone call activation system using the Internet of claim 1, wherein said activating means is equipped to provide a pop-up window at said search engine page which enables inputting a telephone number to be connected with said listed telephone number.

9. The phone call activation system using the Internet of claim 1, which includes means for billing time associated with said call.

10. The phone call activation system using the Internet of claim 9, wherein said billing means is equipped to bill the user.

11. The phone call activation system using the Internet of claim 9, wherein said billing means is equipped to bill said service provider for the call.

12. The phone call activation system using the Internet of claim 1, wherein said activation means is equipped to activate and deactivate said listed number at predetermined times.

13. A phone call activation system and billing system, which includes:
a user's phone having an associated telephone number;
a first CPU operably associated with said user's phone, said first CPU having operating hardware and software and web browser software operably connected to the Internet to permit communicating with search engine software to generate a listed telephone number at a search engine page;
means for activating a call between a second phone associated with said listed telephone number and said user's phone associated with said user's telephone number; and
means for billing time associated with said call.

14. The phone call activation and billing system using the Internet of claim 13, wherein said activating means is equipped to permit entry of a phone number associated with said user's phone.

15. The phone call activation and billing system using the Internet of claim 13, wherein said user's phone is called using wireless electronics.

16. The phone call activation and billing system using the Internet of claim 13, wherein said activating means is equipped to permit entry of an email address.

17. The phone call activation and billing system using the Internet of claim 13, wherein said activating means is equipped for recording said call between said phones to produce recorded call data.

18. The phone call activation and billing system using the Internet of claim 17, wherein said activating means is equipped for automatically transmitting said recorded call data to one of said user and said service provider.

19. The phone call activation and billing system using the Internet of claim 13, wherein said activating means is equipped to send a prompt signal to said second phone to initiate said recording.

20. The phone call activation and billing system using the Internet of claim 13, wherein said activating means is equipped to provide a pop-up window at said search engine page which enables inputting a telephone number to be connected with said listed telephone number.

21. The phone call activation and billing system using the Internet of claim 13, which includes means for billing time associated with said call.

22. The phone call activation and billing system using the Internet of claim 13, wherein said billing means is equipped to bill the user for the call.

23. The phone call activation and billing system using the Internet of claim 13, wherein said billing means is equipped to bill said service provider for the call.

24. The phone call activation and billing system using the Internet of claim 13, wherein said activation means is equipped to activate and deactivate said listed number at predetermined times.
